(19) United States
(12) Patent Application Publication
(10) Pub. No.: US 2014/0237799 A1
(43) Pub. Date: Aug. 28, 2014

(54) INDICIA APPARATUS FOR SELF-CONTAINED BREATHING APPARATUS AND METHODS

(71) Applicants: Zachary L. Green, Wyoming, OH (US); Charles C. Hunt, Wake Forest, NC (US)

(72) Inventors: Zachary L. Green, Wyoming, OH (US); Charles C. Hunt, Wake Forest, NC (US)

(21) Appl. No.: 14/187,377

(22) Filed: Feb. 24, 2014

Related U.S. Application Data
(60) Provisional application No. 61/769,318, filed on Feb. 26, 2013.

(51) Int. Cl. G09F 3/08

(52) U.S. Cl. CPC G09F 3/08
USPC 29/428

(57) ABSTRACT

An indicia apparatus can be provided such as for a self-contained breathing apparatus (“SCBA”). The indicia apparatus can include a hook portion and a plate portion. Indicia can be provided on the plate portion. The indicia can provide at least one of the identity, role, and team affiliation of a person wearing the self-contained breathing apparatus. Methods and kits are also provided.

### REFERENCE TO RELATED APPLICATION

This application claims priority of U.S. provisional patent application Ser. No. 61/769,318, filed Feb. 26, 2013, and hereby incorporates this provisional patent application by reference herein in its entirety.

### TECHNICAL FIELD

An indicia apparatus can be provided such as for a self-contained breathing apparatus (“SCBA”).

### BACKGROUND

SCBA's are conventionally used by firefighters and other personnel to facilitate breathing during hazardous environmental conditions. SCBA's commonly include a mask and an air source. The mask is configured to be worn over at least a portion of the face of the firefighter, for example. The air source is typically provided as a backpack that is worn by the firefighter. The backpack supports an air bottle. A regulator is supported by one or both of the mask and the backpack, and is fluidly coupled with each of the mask and the air bottle.

### SUMMARY

In accordance with one embodiment, a method is provided of manufacturing an indicia apparatus. The method comprises forming a plate portion and a hook portion as a unitary structure with the plate portion. The hook portion extends from a top surface of the plate portion. The hook portion defines a first longitudinal portion, a second longitudinal portion, and a curved portion. The first and second longitudinal portions are separated from one another and are connected together by the curved portion. The method further comprises providing indicia on the plate portion. The first and second longitudinal portions cooperate with the curved portion to define a channel for receiving a band of a strap assembly of a self-contained breathing apparatus. The indicia provides at least one of the identity, role, and team affiliation of a person wearing the self-contained breathing apparatus.

### BRIEF DESCRIPTION OF THE DRAWINGS

Various embodiments will become better understood with regard to the following description, appended claims and accompanying drawings wherein:

FIG. 1 illustrates an SCBA that includes a backpack and a mask, in accordance with one embodiment;

FIG. 2 illustrates an air bottle and an indicia apparatus associated with a portion of the SCBA of FIG. 1;

FIG. 3 is an enlarged rear elevational view depicting the indicia apparatus of FIG. 2 apart from the SCBA;

FIG. 4 is a side elevational view depicting the indicia apparatus of FIG. 3;

FIG. 5 illustrates an indicia apparatus associated with an SCBA, in accordance with an alternative embodiment;

FIG. 6 illustrates an indicia apparatus associated with an SCBA, in accordance with another alternative embodiment; and

FIG. 7 illustrates an indicia apparatus associated with an SCBA, in accordance with yet another alternative embodiment.

### DETAILED DESCRIPTION

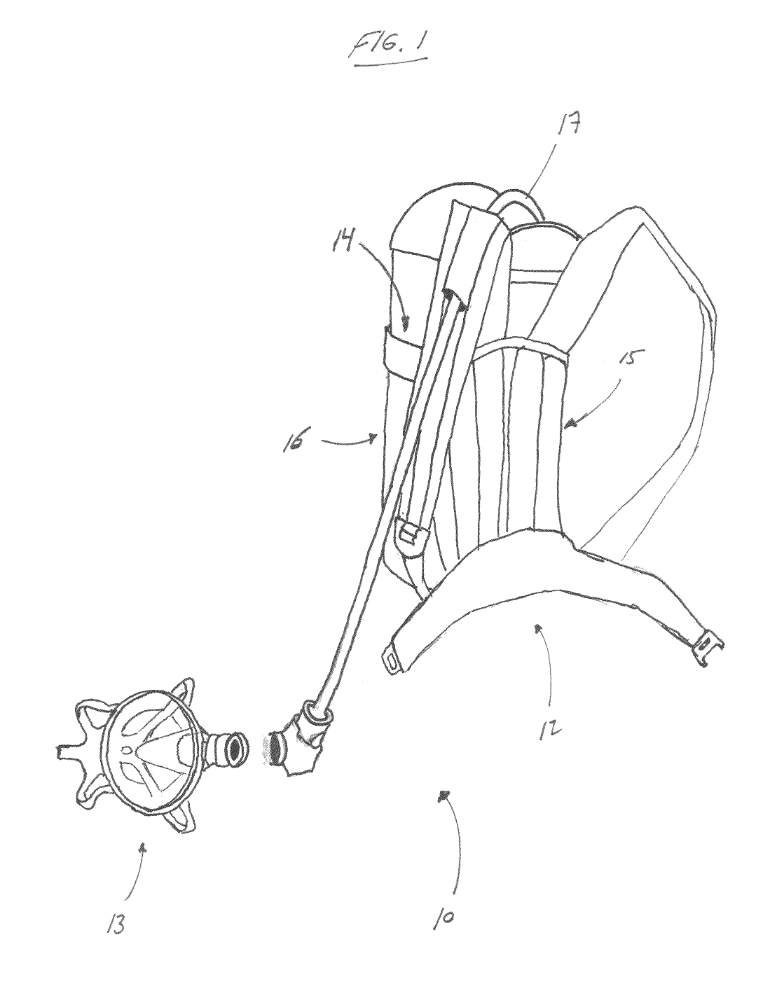

Selected embodiments are hereinafter described in detail in connection with the views and examples of FIGS. 1-7, wherein like numbers illustrate like elements.

FIG. 1 illustrates an SCBA 10 that includes a backpack 12 and a mask 13. The backpack 12 includes a strap assembly 14 which facilitates securement of an air bottle 16 to a frame 15 of the backpack 12, to facilitate retention of the air bottle 16 to a firefighter or other personnel during use of the SCBA 10.

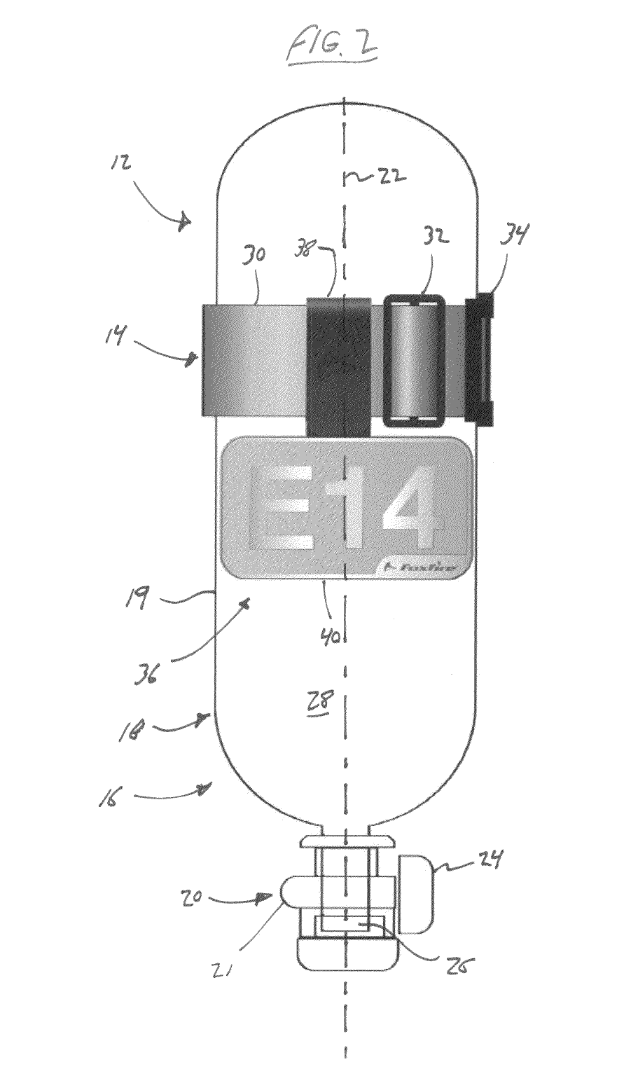

The air bottle 16 can include a bottle portion 18 and a valve portion 20, as shown in FIG. 2. The bottle portion 18 can include an outer wall 19 formed from metal, fiberglass, carbon fiber, some other suitable material or combination thereof, and can define an internal cavity (not shown) for containing pressurized air. The material and manner of construction of the bottle portion 18 can determine the maximum air pressure within the internal cavity of the bottle portion 18. In one embodiment, the internal cavity is sufficiently large such that, when filled to its maximum air pressure, air within the internal cavity is sufficient to provide a firefighter with breathing air for at least between about 15 minutes and about 45 minutes. The outer wall 19 can be generally cylindrically-shaped, can extend along a longitudinal axis 22, and can have a generally round cross-sectional shape, as will be appreciated with respect to FIG. 2.

The valve portion 20 can be attached to the bottle portion 18. The valve portion 20 can include an outlet 21 that can be selectively coupled with a hose 17 (FIG. 1) of the SCBA 10. The valve portion 20 and the hose 17 can together facilitate provision of air to the mask 13 from the internal cavity of the bottle portion 18. In one embodiment, the valve portion 20 can include a handle 24 that can be selectively turned by a hand of the firefighter or other personnel, to selectively facilitate fluid coupling or uncoupling of the internal cavity with the mask 13. The valve portion 20 can also include an air pressure gauge 26 and/or a pressure relief valve (not shown).

The strap assembly 14 can be selectively reconfigurable by the firefighter or other personnel between a tightened position (shown in FIG. 2), and a loosened position (not shown). When the strap assembly 14 is in the loosened position, the air bottle 16 can be easily removed from the backpack 12. However, when the strap assembly 14 is in the tightened position, the air bottle 16 can be retained by the backpack 12. In one embodiment, when the strap assembly 14 is in the tightened position, other portions of the backpack 12 can engage the air bottle 16, to cooperate with the strap assembly 14, to facilitate securement of the air bottle 16 to the frame 15 of the backpack 12. For example, a portion of the frame 15 can engage the valve portion 20. Additionally, one or more other portions of the frame 15 can contact an outer surface 28 of the outer wall 19 of the bottle portion 18, in a generally complementary configuration, to facilitate a secure and tight fit of the air bottle 16 with respect to the frame 15 when the strap assembly 14 is in the tightened position.

The strap assembly 14 can comprise a band 30 that can be generally tightened or loosened with respect to the frame 15 of the backpack 12, to facilitate grasping or releasing of the air bottle 16 relative to the frame 15. The strap assembly 14 can be provided in any of a variety of suitable configurations. For example, in one embodiment, as shown in FIG. 2, the band 30 can comprise a flexible webbing material that can be selectively adjusted through use of an adjustment ring 32, and can comprise a clasp 34. The clasp 34 can selectively engage and disengage the frame 15 to facilitate tightening and loosening of the band 30, respectively, and thus grasping and releasing of the air bottle 16, respectively. Alternatively, the clasp 34 can selectively move relative to the frame 15 between first and second engaged positions to facilitate tightening and loosening of the band 30, respectively, and thus grasping and releasing of the air bottle 16, respectively. It will be appreciated that a band of a strap assembly can instead be provided as a sheet of flexible metal, or in any of a variety of other suitable configurations.

It can be beneficial to include indicia on firefighters and other personnel so that their identity, role, and/or team affiliation can be readily identified. To the extent that such indicia is provided on a rear surface of a jacket worn by a firefighter, the indicia can be obscured from view by the SCBA 10 when worn by the firefighter. If such indicia is provided on the air bottle 16 of the SCBA 10, since air bottles are often replaced at least once during the course of a given event (e.g., a fire scene), care would have to be taken to ensure that the proper indicia is applied to the replacement air bottle, each time the air bottle 16 is replaced. Accordingly, benefits can be achieved if such indicia is instead associated with the backpack 12 of the SCBA 10, and more particularly, the band 30 of the strap assembly 14.

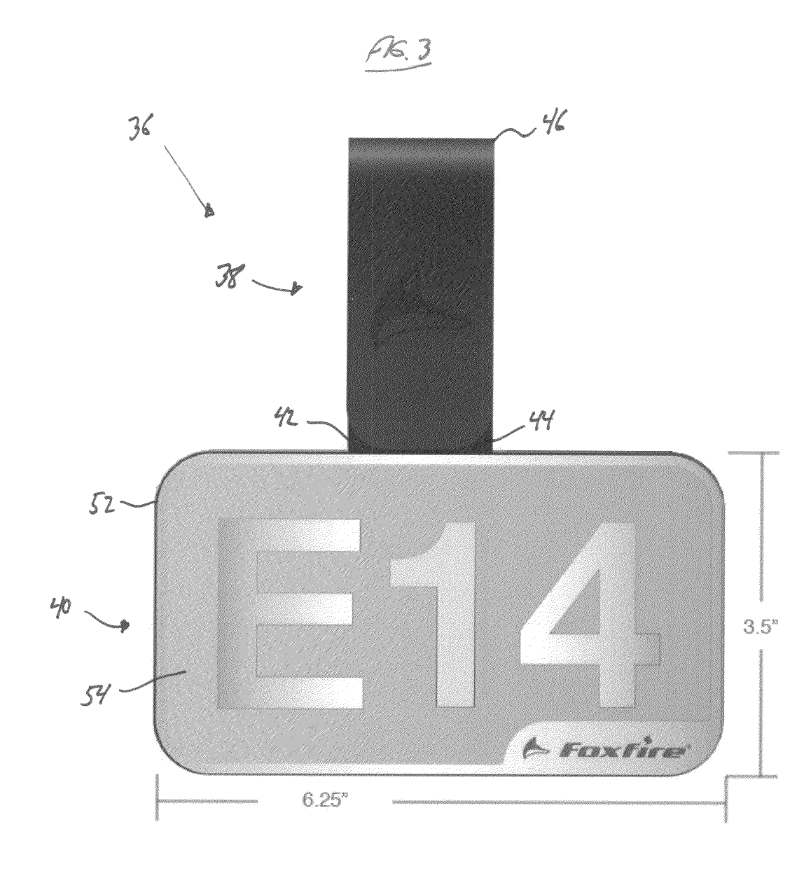

For example, in one embodiment, as shown in FIG. 2, an indicia apparatus 36 can be associated with the band 30 of the strap assembly 14 of the SCBA 10. More particularly, the indicia apparatus 36 is shown to include a hook portion 38 and a plate portion 40. The hook portion 38 can facilitate attachment of the indicia apparatus 36 to the band 30, while the plate portion 40 can include indicia that provides the identity, role, and/or team affiliation of the person wearing the SCBA 10. The hook portion 38 can extend from a top surface of the plate portion 40, either offset from the longitudinal axis 22 toward one side of the plate portion 38 (e.g., toward the left side as shown in FIGS. 2-3, to facilitate centering of the indicia apparatus 36 relative to the air bottle 16 despite presence of the adjustment ring 32 on the band 30), or in another embodiment centered along the longitudinal axis 22 (not shown).

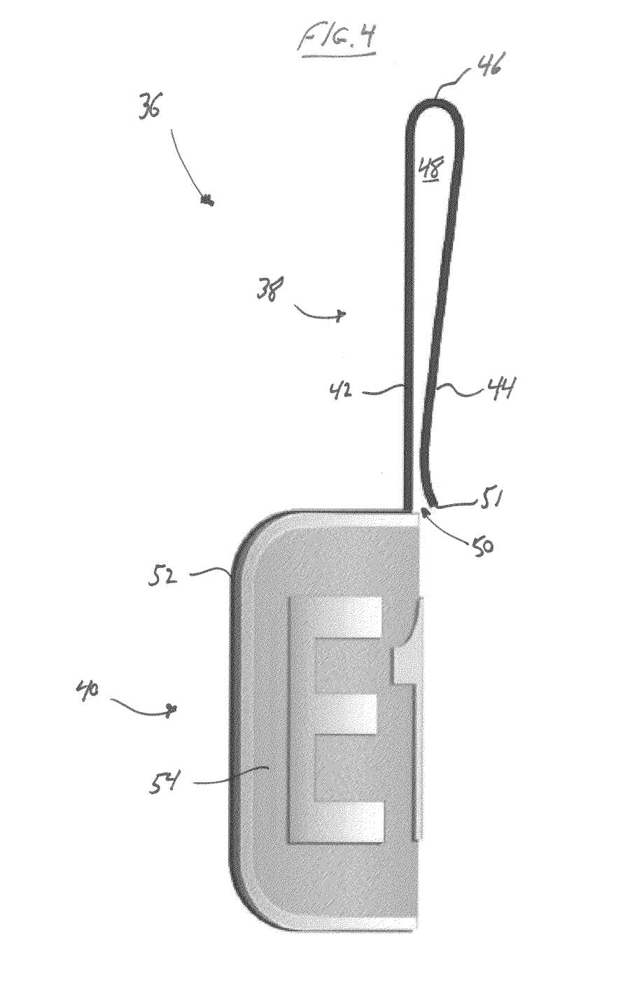

FIGS. 3-4 are enlarged rear and side elevational views, respectively, depicting the indicia apparatus 36 apart from the SCBA 10. The hook portion 38 can be formed as a unitary structure such as from metal, for example, to define first and second longitudinal portions 42, 44 that are separated from one another but connected together with a curved portion 46. The first and second longitudinal portions 42, 44 cooperate with the curved portion 46 to define a channel 48 for receiving the band 30 of the strap assembly 14. When the band 30 is received in the channel 48, as shown in FIG. 2, the first and second longitudinal portions 42, 44 can sandwich the band 30 and can each extend generally parallel with the longitudinal axis 22. In one embodiment, as shown in FIG. 4, the first and second longitudinal portions 42, 44 can approach or contact one another opposite the curved portion 46 (near the region marked 50 in FIG. 4), to assist in facilitating prevention of inadvertent release of the hook portion 38 from the band 30. A free end 51 of the hook portion 38 is shown to be positioned to face away from the air bottle 16, and to be separated from the air bottle 16 by another part of the indicia apparatus 36 (e.g., the first longitudinal portion 42), to prevent the free end 51 from contacting and possibly damaging the air bottle 16, and to assist in facilitating prevention of inadvertent release of the hook portion 38 from the band 30.

The plate portion 40 can include a backing member 52. In one embodiment, the backing member 52 can be formed as a unitary structure with the hook portion 38, such as from metal such as stainless steel (e.g., in a stamping process), plastic (e.g., in a molding process), a composite, or another material that is suitable to withstand heat and other conditions of the intended service conditions of the SCBA 10. The backing member 52 can have a curved shape to complement and contact the outer surface 28 of the outer wall 19 of the bottle portion 18 of the air bottle 16. This curved shape can be appreciated with reference to FIG. 4. The respective shapes of the hook portion 38 and the plate portion 40 can cooperate to facilitate prevention of inadvertent release of the hook portion 38 from the band 30.

The plate portion 40 can also include indicia 54 that is applied to the backing member 52. The indicia 54 can be provided in any of a variety of suitable configurations. For example, with reference to FIGS. 3-4, the indicia 54 can include a paint or coating that is applied to the backing member 52 to define the alphanumeric symbol “E14”. The symbol “E14” can facilitate identification of a wearer of the SCBA 10 as being a member of a team or crew of fire engine truck #14. It will be appreciated that a paint or coating can be applied to a backing member in any of a variety of other suitable configurations, and to define any of a variety of other suitable numeric, alphabetical, alphanumeric, or other symbols, and in any of a variety of colors and/or color patterns. In one embodiment, the paint or coating can comprise a phosphorescent or other glow-in-the-dark material, such as luminescent vinyl. Reflective graphics can be laser cut and adhered or printed directly on the vinyl. In one embodiment, the indicia 54 can include adhered luminescent and reflective layers which can provide a highly visible background and contrasting designations.

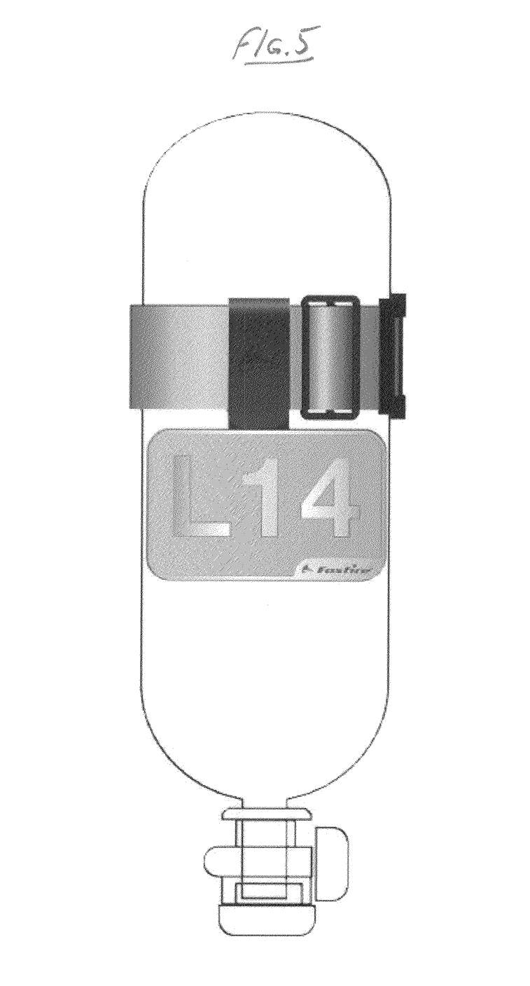

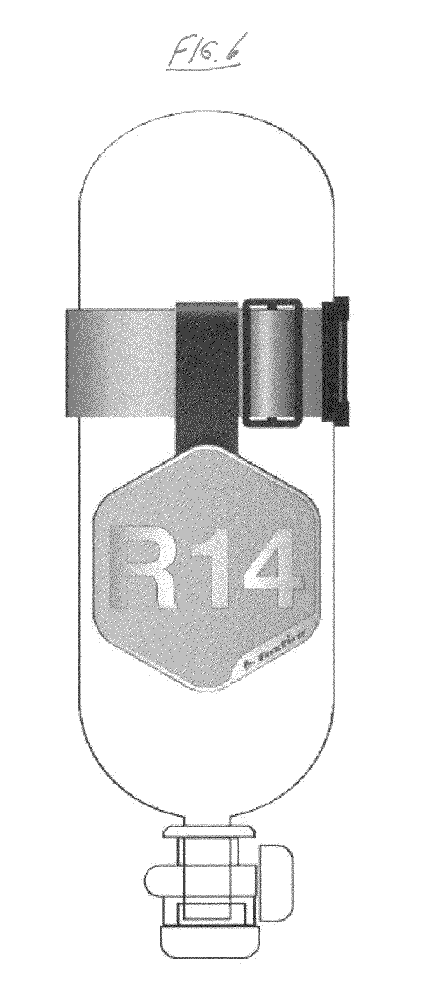

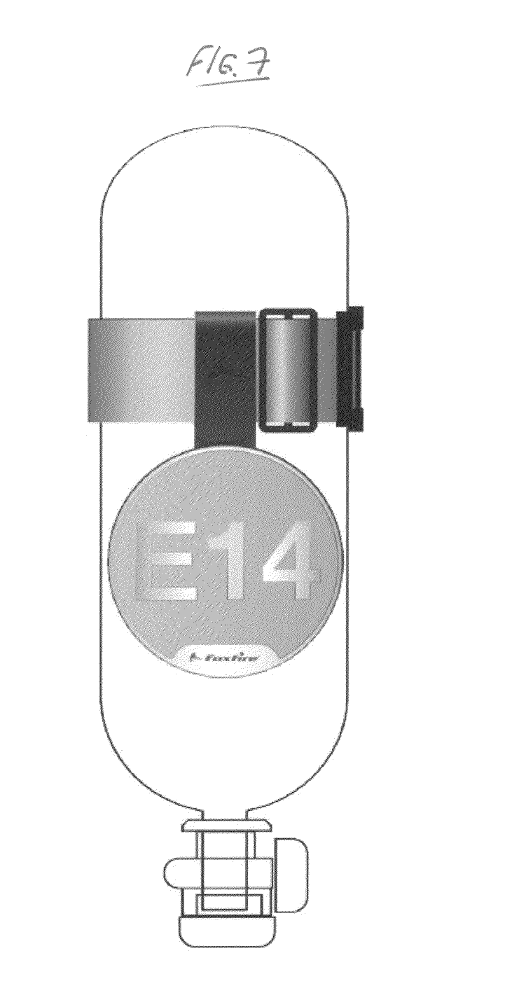

The shape of the backing member 52 can also serve to provide indicia. For example, in the example of FIGS. 2-4, the backing member 52 is shown to have a generally rectangular shape. As shown in FIG. 3, the backing member 52 can be about 6.25″ wide and about 3.5″ tall, though it will be appreciated that a backing member can have any of a variety of other suitable dimensions. FIG. 5 also illustrates an indicia apparatus associated with an SCBA, and having a generally rectangular-shaped backing member, but with indicia on the backing member defining the alphanumeric symbol “L14”. The symbol “L14” can facilitate identification of a wearer of the associated SCBA as being a member of a crew of fire ladder truck #14. FIG. 6 illustrates an indicia apparatus associated with an SCBA, having a generally hexagon-shaped backing member, and with indicia on the backing member defining the alphanumeric symbol “R14”. The symbol “R14” can facilitate identification of a wearer of the associated SCBA as being a member of a crew of fire rescue truck #14. FIG. 7 illustrates an indicia apparatus associated with an SCBA, having a generally circular-shaped backing member, and with indicia on the backing member defining the alphanumeric symbol “E14”. The symbol “E14” can facilitate identification of a wearer of the associated SCBA as being a member of a crew of fire engine truck #14. In other examples, backing members of indicia apparatus can have any of a variety of other suitable shapes.

Due to the difference among the shapes of the backing members of the respective indicia apparatus of FIGS. 5-7, a firefighter wearing the SCBA with the associated indicia apparatus can be quickly and easily identified as a member of the crew of fire ladder truck #14, fire rescue truck #14, and fire engine truck #14. Also, due to the difference among the indicia provided on the backing members of the respective indicia apparatus of FIGS. 5-7 (i.e., “L14”, “R14” and “E14”), a firefighter wearing the SCBA with the associated indicia apparatus can be quickly and easily identified as a member of the crew of fire ladder truck #14, fire rescue truck #14, and fire engine truck #14. In another embodiment, due to difference among color(s) or color patterns of backing members of respective indicia apparatus, a firefighter wearing the SCBA with the associated indicia apparatus can be quickly and easily identified as a member of the crew of a fire ladder truck, a fire rescue truck, and a fire engine truck. It will be appreciated that indicia apparatus can be used to identify wearers of SCBA's (individually and/or as crews or teams) other than firefighters such as, for example, hazardous materials remediation workers, confined space workers, and others.

The indicia apparatus 36 can be simple to make, inexpensive, and lightweight. When the air bottle 16 is replaced with another air bottle 16, the indicia apparatus 36 can remain coupled with the strap assembly 14 and can be configured not to impede the process of replacing the air bottle 16. A kit of indicia apparatus can include several identical indicia apparatus to outfit SCBA's of a particular fire truck, for example. Another kit of indicia apparatus can include several groups of indicia apparatus to outfit SCBA's, with each indicia apparatus of a group being identical to the other indicia apparatus of the same group, but different than the indicia apparatus of the other groups. For example, a kit might include five of the indicia apparatus of each of FIGS. 5, 6, and 7, for a total of three groups and fifteen indicia apparatus. It will be appreciated that, in other embodiments, a kit of indicia apparatus can include fewer than two groups or more than two groups, groups of a kit can include the same number or differing numbers of indicia apparatus, and a group can include as few as one indicia apparatus or any number greater than one indicia apparatus.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art.

What is claimed is:

1. A method of manufacturing an indicia apparatus, the method comprising:
forming a plate portion;
forming a hook portion as a unitary structure with the plate portion, the hook portion extending from a top surface of the plate portion, the hook portion defining a first longitudinal portion, a second longitudinal portion, and a curved portion, the first and second longitudinal portions being separated from one another and connected together by the curved portion; and
providing indicia on the plate portion; wherein
the first and second longitudinal portions cooperate with the curved portion to define a channel for receiving a band of a strap assembly of a self-contained breathing apparatus; and
the indicia provides at least one of the identity, role, and team affiliation of a person wearing the self-contained breathing apparatus.
